(19) United States
(12) Patent Application Publication
(10) Pub. No.: US 2023/0415158 A1
(43) Pub. Date: Dec. 28, 2023

(54) SAMPLE ANALYSIS CARTRIDGE

(71) Applicant: TTP PLC., Royston, Hertfordshire (GB)

(72) Inventors: Piers HARDING, Royston, Hertfordshire (GB); Matt WILLIAMS, Royston, Hertfordshire (GB); Andrew MALLOY, Royston, Hertfordshire (GB); Rebecca HOWARD, Royston, Hertfordshire (GB)

(21) Appl. No.: 18/036,692

(22) PCT Filed: Nov. 12, 2021
(86) PCT No.: PCT/GB2021/052930

§ 371 Date: May 12, 2023

(30) Foreign Application Priority Data
Nov. 13, 2020 (GB) 2017920.6

(51) Int. Cl. B01L 3/00

(52) U.S. Cl. CPC B01L 3/52; B01L 3/502; B01L 2200/026; B01L 2200/0689; B01L 2200/10; B01L 2200/12; B01L 2200/16; B01L 2300/12

(57) ABSTRACT

There is provided sample analysis cartridges comprising a housing defining a reaction chamber configured to receive a sample, a dry reagent storage chamber, and a fluid reagent storage chamber, and a reagent supply mechanism for selectively supplying reagent from the dry and fluid storage chambers during an analysis, wherein the dry reagent storage chamber comprises a liner formed from a material having a lower fluid permeability than the material from which the housing is formed.

### RELATED APPLICATION

The present application is a national stage application under 35 U.S.C. § 371 of International Application No. PCT/GB2021/052930, filed Nov. 12, 2021, which claims priority to Great Britain Patent Application No. 2017920.6, filed Nov. 13, 2020. The above referenced applications are hereby incorporated by reference in their entirety.

### FIELD

The present invention relates to cartridges and systems for preparing and analysing samples and methods of preparing and analysing samples using such devices. The invention provides fast and accurate preparation and analysis of samples, and a quick and convenient disposal of samples after use.

### BACKGROUND

In the field of diagnostics there has been a growing need to provide sample preparation devices that can be used in the analysis of a sample from a patient. In particular there has been a growing need for ‘point-of-care’ medical diagnostic devices that enable a sample to be analysed at the location of a patient to ensure rapid analysis and to improve overall care for the patient.

One analytical approach which is desired to be implemented in such a point-of-care device is polymerase chain reaction (PCR). PCR is a technique in which small samples of segments of DNA and RNA are amplified or copied to provide larger quantities of the sample to study in detail. During this process a purified eluate containing the DNA or RNA in question is thermal cycled to amplify and detect the DNA or RNA in question.

Such analysis often uses a cartridge that contains wet and dry reagents to perform the DNA/RNA extraction, purification and amplification. The dry reagents are either in the form of cakes, that are directly lyophilised in the cartridge, or small beads, that are placed into the cartridge. In both cases, they are extremely hydroscopic.

To be effective over the shelf life of the product, the lyophilised reagent must be stored in a very low moisture environment (<5% RH). Unfortunately, such cartridges are typically manufactured from materials with poor moisture barrier properties, such as polypropylene. Consequently, the design of the dry chamber within the cartridge faces several potential challenges.

They must maintain a low RH within the dry chamber during assembly and must prevent moisture migrating from the fluid reagent chambers into the dry chamber over the specified shelf life. They should provide the ability for the system to open the chambers during use and must keeping the system simple, by not asking the user to carry out additional assembly tasks when performing a test (such as snapping in a separate chamber from a secondary foil pouch)

Existing cartridges use different methods to improve shelf life but these all have drawbacks.

One approach is to employ large amounts of desiccant, stored within the cartridge packaging, to maintain a low moisture environment within the cartridge. However, this requires additional volumes of fluid reagents which increases the overall size and cost of the cartridge. Also, it is shelf life limited and the desiccant adds to overall cost.

Another approach is to have desiccant stored within the dry chamber, to maintain a low moisture environment. However, this requires a large ratio of desiccant to lyophilised reagent and can make rehydration difficult due to the need to avoid desiccant mixing with the elution. It is also, shelf life limited.

Yet a further approach is to store the dry reagents separately from the wet reagents and ask the user to assemble both prior to use. This significantly impacts the risk of the user making a mistake. It also adds to the packaging costs.

### SUMMARY OF INVENTION

In accordance with an aspect of the invention there is provided a cartridge according to the claims.

The present invention takes advantage of the provision of a liner formed from a low permeability material to enable formation of the main housing of the sample analysis cartridge from low cost and readily available plastics materials whilst improving dry reagent shelf life within the cartridge through use of lined and sealed dry reagent storage chambers. The invention can also simplify and improve manufacture by enabling production of the liner component as a separate sealed unit prior to assembly of the cartridge.

### BRIEF DESCRIPTION OF DRAWINGS

Specific examples of the invention will now be discussed with reference to the following drawings:

FIG. 1 shows an expanded view of a sample analysis cartridge according to an example of the invention;

FIG. 2 shows views of liner components for use in the cartridge of FIG. 1;

FIG. 3 shows a comparison of the permeability rates of different polymers that may be used in a cartridge according to the invention;

FIG. 4 is a schematic drawing showing moisture transmission in seal employed in an example of the invention; and

FIG. 5 is a graph showing experimental data showing moisture ingress into polypropylene and aluminium containers.

### DETAILED DESCRIPTION

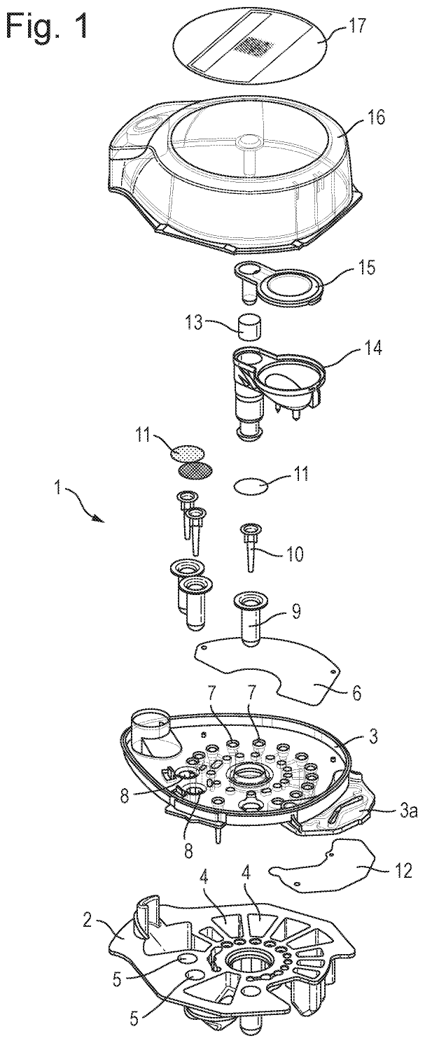

An example sample analysis cartridge 1 according to the invention is shown in expanded plan view in FIG. 1.

The sample analysis cartridge 1 comprises base moulding 2 covered by a dip tube moulding 3.

The base moulding 2 forms part of a housing for the sample analysis cartridge 1 and is moulded to define at least one liquid reagent chamber 4 and at least one dry reagent chamber 5. In the examples shown plural chambers 4,5 of both type are provided. During manufacture liquid reagent is placed in the chamber or chambers 4, the dip tube moulding 3 is sealed, preferably by welding, on to the base moulding 2 and an optional low fluid permeability barrier 6 placed over apertures 7 in the dip tube moulding 3 to seal the liquid contained within the liquid reagent chambers 4 in place and prevent leakage of those liquid reagents during transport and handling. Other apertures 8 within the dip tube moulding 3 sit above the dry reagent chambers 5. Liners 9 are inserted via the apertures 8 and sit within and line of the dry reagent chambers 5. The liners 9 are also made of a low fluid permeability material, such as a metal. One particularly cost effective and functionally effective metal is aluminium. Dry reagent is provided or placed inside each of the liners 9, either during manufacture of the sample analysis cartridge 1, or prior to insertion of the liners 9 into the apertures 8. Held within each liner 9 may be other components, such as a small amount of desiccant to improve shelf life of the dry reagents, as well as other components such as reagent dip tubes 10 that are used during operation of the sample analysis cartridge 1 during use. Each of the linings 9 is then sealed with a cover 11 as will be described in more detail below. FIG. 1 also shows an additional low fluid permeability barrier 12 which may be inserted between the base moulding and the dip tube moulding 2 to protect other components that can be held in the base moulding if required. In addition, FIG. 1 shows pipette filter and pipette moulding components 13, 14 which are covered by a pipette cover 15. Atop moulding 16 sits above all these components to provide the remainder of the housing of the cartridge 1. A label 17 is then usually provided to ensure reliable handling of the cartridge and to assist in use of the cartridge in any automated procedure. The housing defines a reaction chamber 3a configured to receive a sample (e.g. for analysis). The sample may be formed using reagent(s) from one or more of the reagent chambers 4, 5. As

seen in FIG. 1 the reaction chamber 3a is formed as part of the dip tube moulding 3 (although this is not essential).

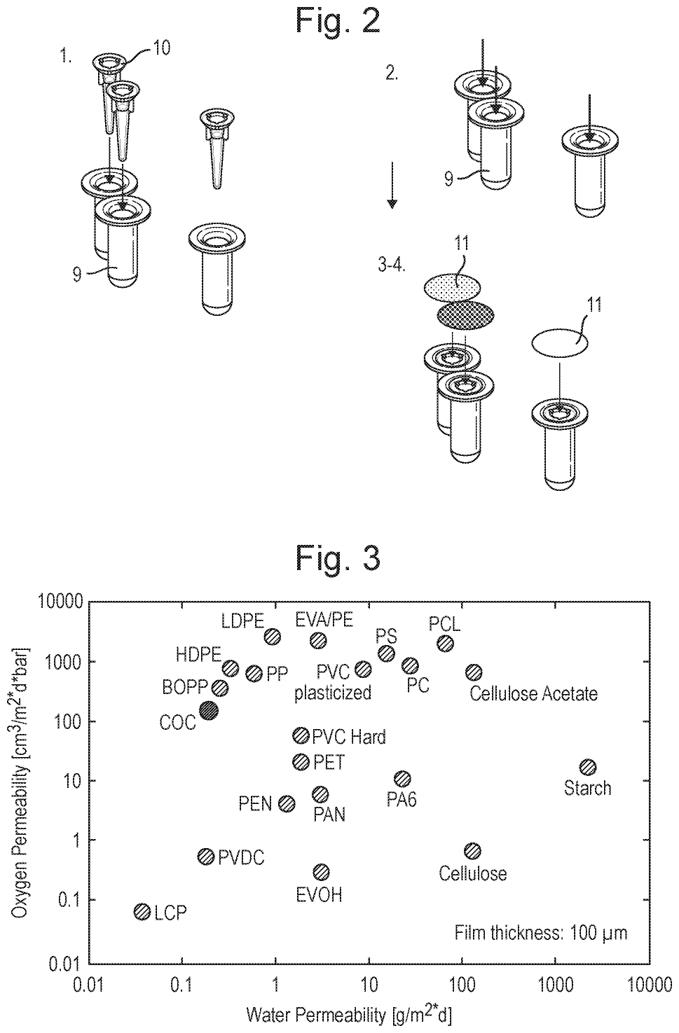

In this particular example, during use the sample analysis cartridge 1 is inserted into a system (not shown) and a driving mechanism is passed via the central core of the base moulding 2 to engage with the pipette moulding 14 and raise and rotate it to selectively engage with desired liquid reagent and dry reagent chambers 4, 5 as required by a particular analysis. Thus the pipette moulding 14 acts as a reagent supply mechanism and may selectively supply reagent from the dry and fluid storage chambers 4, 5 (e.g. to the reaction chamber 3a and/or other chambers within the housing). The pipette moulding 14 may comprise one or more pipettes configured to receive and supply reagent(s). It will be appreciated by a person skilled in the art that other methods of accessing the reagent chambers 4, 5 are possible whilst still employing the concept of ensuring reliable storage of dry and/or liquid reagents in accordance with the invention. Referring to FIG. 2, the structure of the liners 9 which comprise the low fluid permeability material is shown in more detail. In this example aluminium is used, but other metals or high barrier plastics (such as LCP) can be employed. In this particular example dip tubes 10 are inserted into each liner 9. The dip tubes can be formed of a plastics material, and may comprise desiccant within that material to help absorb moisture within the liner 9. In addition, or as an alternative, the liner 9 or the dip tube 10 can include a pocket to contain desiccant therein. Once the dip tube 10 has been inserted then dry reagent may be placed within the dip tube. Alternatively, reagent may be introduced, wet, down the dip tube 10, and subsequently lyophilised (i.e. freeze-dried) in situ so as to form dry reagent. After dry reagent is provided within the liner 9 a seal 11 is placed over the liner 9 to provide a sealed lining unit which can line a dry reagent chamber 5 within the sample analysis cartridge 1. The seal component 11 should also be formed of a low fluid permeability material, such as aluminium foil, and can be joined (e.g. adhered or welded) to the main body of the liner 9. The liner 9 can be formed separate to the sample analysis cartridge 1 and then inserted into its respective dry reagent chamber 5 during manufacture of the sample analysis cartridge 1. Individual sealing components 11 can be coloured differently to aid in such

assembly so as to indicate different reagent types contained therein. As will be appreciated, the seal 11 may be structured so that it can be pierced in use so that during operation the dry reagent can be removed from its respective dry reagent chamber 5, normally by rehydration of the dry reagent and then drawing up into the system.

At present sample analysis cartridges are usually made of a low cost plastics material such as polyethylene or polypropylene. These have reasonably low rates of moisture permeability, as shown in FIG. 3. However, over significant periods of time they do absorb water from the atmosphere which can pass into storage chambers within the cartridge and damage the reagents stored therein. This moisture permeability therefore results in a short shelf life for sample analysis cartridges which can be a significant problem. Proposals have been made to use lower permeability plastic materials, such as liquid crystal polymer, but these are expensive and increase significantly the cost of the cartridge.

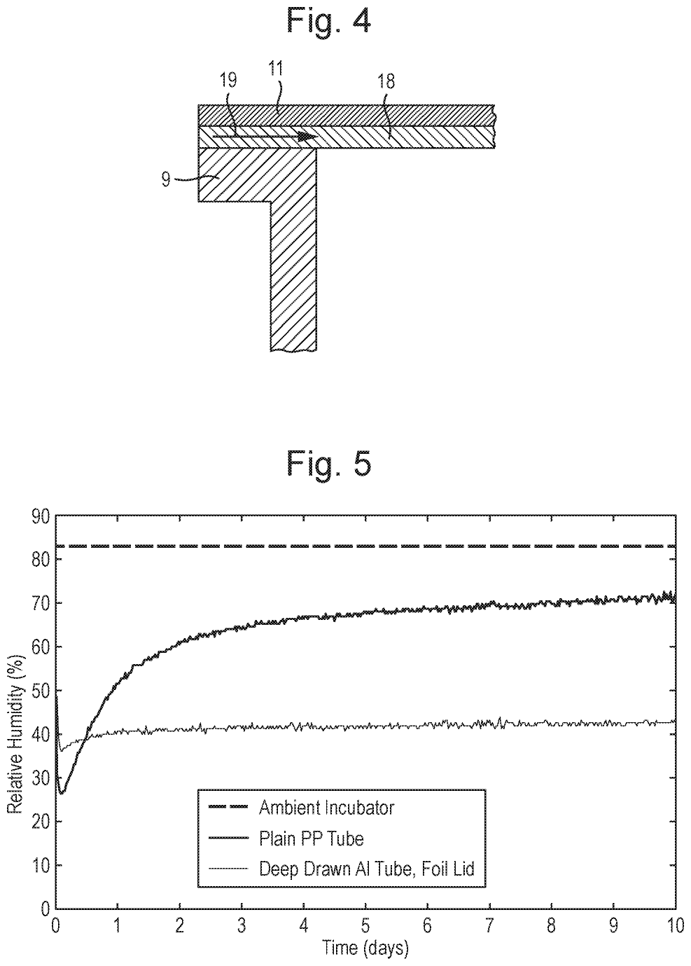

Metals, particularly aluminium, are not affected in the same way and are virtually impermeable to fluids, particularly moisture, when they are above a certain thickness. The present invention takes advantage of this by providing the liner 9 formed from such a material as it enables formation of the main housing of the sample analysis cartridge 1 from low cost and readily available plastics materials whilst improving dry reagent shelf life within the cartridge through use of sealed chambers 5. As will be appreciated, whilst an aluminium liner 9 with the appropriate seal 11 should be virtually impermeable to moisture, in practice a sealing layer 18 (FIG. 4) may be required between the seal 11 and the liner 9. This creates a moisture transmission path 19 as shown in FIG. 4. The seal 18 is usually a polymer adhesive and over time may allow moisture ingress into the dry reagent chamber 5. The problem associated with this can be reduced either by increasing the length of the moisture transmission path 19 by having an extended lip on the engaging surface between the liner 9 and seal 11, by reducing the thickness of the sealing layer 18, or by introducing desiccant, in a relatively small volume, into the liner 9 before it is sealed. This can be done, as mentioned above, either by introducing desiccant into the structure of any dip tube 10 or other component stored with the dry reagent, or by holding desiccant within the dip tube 10, or through the seal 11 holding desiccant, or a combination thereof.

Alternatively, the seal 11 may be joined directly to the liner 9 by welding. As such, a sealing layer 18 may not be necessary between the seal 11 and the liner 9, and moisture ingress into the dry reagent chamber 5 may be significantly reduced. This approach is especially effective where the seal 11 and liner 9 are both metals (e.g. aluminium), and preferably the same metal. To further reduce moisture ingress, desiccant may be introduced into the liner 9 before it is welded closed using any of the techniques discussed above.

As mentioned above, the materials used in conventional sample analysis cartridges do have significant issues with fluid permeability, particularly in relation to moisture ingress. As shown in FIG. 5, the changing relative humidity inside similar sealed tubes of polypropylene and aluminium are shown when both are kept in the same high humidity environment. It can be seen that over the period of a week humidity inside the polypropylene tube rapidly approaches equilibrium with a humid environment whereas in the aluminium tube it remains close to its initial level and rises only very slowly. This is a clear indicator that the provision of dry reagent chambers 5 with appropriate liner construction, in accordance with the invention, can significantly improve shelf life of the overall sample analysis cartridge 1.

1. A sample analysis cartridge, comprising:
a housing comprising:
a reaction chamber configured to receive a sample,
a dry reagent storage chamber, and
a fluid reagent storage chamber; and
a reagent supply mechanism for selectively supplying a reagent from one of the dry reagent storage chamber and the fluid reagent storage chamber during an analysis;
wherein the dry reagent storage chamber comprises a liner formed from a material having a lower fluid permeability than a housing material.

2. The sample analysis cartridge according to claim 1, wherein the liner is structured as a sealed capsule configured to be inserted into the dry reagent storage chamber during manufacture of the sample analysis cartridge.

3. The sample analysis cartridge according to claim 2, wherein the sealed capsule comprises a breakable seal which can be broken by the reagent supply mechanism to retrieve dry reagent therefrom in use.

4. The sample analysis cartridge according to claim 1, wherein the material of the liner is a metal, preferably aluminium.

5. The sample analysis cartridge according to claim 1 wherein the dry reagent storage chamber has a region therein for storing desiccant material.

6. The sample analysis cartridge according to claim 1, further comprising a plurality of dry reagent storage chambers, wherein a respective liner for each of the plurality of dry reagent storage chambers comprises a material having a lower fluid permeability than the housing material, and wherein each of the plurality of dry reagent storage chambers is sealed separately to one another.

7. The sample analysis cartridge according to claim 1, further comprising a barrier between the dry reagent storage chamber and the fluid reagent storage chamber, the barrier formed from a material having a lower fluid permeability than the housing material.
